(19) United States
(12) Patent Application Publication
(10) Pub. No.: US 2020/0338688 A1
(43) Pub. Date: Oct. 29, 2020

(54) METHOD FOR AUTOMATICALLY VERIFYING AND CLEANING LARGE-SIZED PARTICLE COUNTER FOR ANALYZING CMP SLURRY AND VERIFICATION SYSTEM SUITABLE FOR SAME

(71) Applicant: LTH CO., LTD., Seoul (KR)

(72) Inventor: Ki Woo Hong, Seoul (KR)

(21) Appl. No.: 16/777,088

(22) Filed: Jan. 30, 2020

Related U.S. Application Data
(63) Continuation of application No. PCT/KR2019/012961, filed on Oct. 4, 2019.

(30) Foreign Application Priority Data
Apr. 25, 2019 (KR) 10-2019-0048532
Apr. 25, 2019 (KR) 10-2019-0048533

(51) Int. Cl. B24B 37/005; G01N 15/02; B24B 57/02

(52) U.S. Cl. CPC B24B 37/005; B24B 57/02; G01N 15/02

(57) ABSTRACT

Provided is an automatic verification method of a large-sized particle counter for analyzing CMP slurry in a slurry delivery system, which includes a delivery apparatus for manufacturing and delivering slurry using raw materials, and an analyzer having a sensor receiving a slurry sample to inspect whether or not the slurry is abnormal. If a measurement value of the analyzer exceeds a permissible range and an abnormal signal is generated, supplying a standard material instead of the slurry to the analyzer; if the standard material measurement value is within a predetermined normal range, judging that there is abnormality in slurry and inspecting the raw material or the delivery apparatus to find a cause of the abnormality; and if the standard material measurement value exceeds the normal range, judging that there is abnormality in the analyzer and taking measures to solve the problem of the analyzer.

### TECHNICAL FIELD

The present invention relates to a method for establishing a cause of an abnormal signal of slurry when the abnormal signal of slurry is generated while slurry is prepared in a delivery system in order to deliver slurry to a CMP process and a slurry verifying system suitable for the method, and more particularly, to a method and a system for more rapidly and accurately establishing whether abnormality of slurry is the result of raw materials supplied for manufacturing slurry, of the delivery apparatus for making slurry with raw materials, or of an analyzer for inspecting the slurry and for rapidly taking measures as occasion demands.

### BACKGROUND ART

Lots of semiconductor manufacturing processes are conducted while slurry is supplied to manufacturing facilities. Most of such processes are conducted automatically and need to always or frequently check whether or not there is abnormality in the processes, and such checking is also conducted automatically by arranging a process sensor for sensing abnormality in the processes.

Meanwhile, even in a delivery system for delivering slurry to a main process and a slurry verifying system, in order to prevent a much bigger problem from coming up, slurry is supplied after whether the slurry to be supplied is wrong or not is decided. The slurry verifying system for an accurate manufacturing process, such as a semiconductor manufacturing process, generally adopts such a method.

If a chemical mechanical polishing (CMP) process for forming a multi-layered circuit inside a substrate (wafer) for high-density micro-integration and flattening the substrate is conducted, an abrasive in which chemicals and physical particle slurry are mixed together is supplied to the surface of the substrate and a pad rubs the surface of the substrate to grind and flatten the surface of the substrate.

For the CMP process, a required amount of chemicals and a required amount of physical particle slurry are respectively delivered from a chemicals storage and a physical particle slurry storage of an abrasive supply device, are mixed evenly, and are filtered. After that, it is checked that sizes of slurry particles in the abrasive, the mixture ratio, hydrogen ion concentration, density, conductivity, and others meet predetermined conditions, and then, the mixture is supplied to the main process.

FIG. 1 is a conceptual diagram showing a system including a delivery apparatus for delivering slurry, an analyzer which is identified with a slurry verifying system for inspecting abnormality of slurry or is considered as a subordinate concept of the slurry verifying system, and a passage for transmitting a signal between the delivery apparatus and the analyzer.

Referring to FIG. 1, the delivery apparatus 10 includes a mixing device, a filtering device and others, and the analyzer 20 includes one or more sensors, a preprocessor for making the slurry measurable by a sensor as occasion demands, and a control unit for converting a sensor output signal into a numerical value.

According to circumstances, the preprocessor is not needed, and the analyzer may be called a sensor since the control unit may be a part of sensor.

In such a system, the delivery apparatus 10 serves to mix and filter raw materials and deliver slurry to a main process 2 through a delivery line 15, and sends a manufactured slurry sample to the analyzer 20 through a sample line 13. The delivery apparatus includes a main controller to generate an analyzer control signal, to send the analyzer control signal to the analyzer through a signal transmission line 11, and to receive a measured result 21 or a measurement value of the analyzer through a signal receiving line 21.

The system is very effective since conducting processes automatically and inspecting abnormality of slurry automatically. However, if the analyzer senses abnormality of the slurry, it is not easy to check whether abnormality of the slurry is the result of the delivery apparatus 10, of wrong raw materials or of an analyzer.

If there is an abnormal signal, or if the measurement value by the analyzer exceeds a predetermined normal value range, there is a problem that it is not certain to consider the abnormality as abnormality of the slurry. That is, the measurement value relative to normal slurry may exceed a normal range due to malfunction of an analyzer sensor.

FIG. 2 is a flow chart showing a process or steps of measuring the analyzer in the conventional system. Referring to FIGS. 1 and 2, when measurement starts (S10), the delivery apparatus operates some of valves through the sample line at all times, periodically or if necessary to send a slurry sample to the analyzer, and send a start signal to the analyzer.

When the analyzer receives the start signal, measurement starts (S20). The analyzer measures a characteristic value of the slurry sample, derives a measurement value, and transmits the measurement value to a PLC of the delivery apparatus to form a signal feedback (S30). Of course, the analyzer may have a plurality of sensors to measure various characteristic values of the slurry sample, and the sensors may derive measurement values of characteristics that they take charge in and send the measurement values to the delivery apparatus.

The delivery apparatus analyzes the measurement value (S40), generates a warning signal that the slurry is abnormal (S50) if the measurement value exceeds the normal range, so that a person in charge of the slurry verifying system or an engineer can take measures to solve the problem (S60). If necessary, the warning signal may be a shutdown signal to interrupt delivery of the slurry.

In case of a general process, a process engineer stops the process, investigates abnormality-causing elements in order to find the cause of abnormality, and removes the cause. After that, the process is performed again.

Moreover, if the problem is solved or the measurement value is normal, the delivery system is in a standby state for the next analysis (S70).

However, recently, lots of modernized automatic facilities manufacture higher value-added products, and discontinuity in process may cause a great loss since some of the facilities need consistent work. If the process is stopped due to a simple abnormality in the analyzer even though there is no problem in other facilities or slurry, it may be waste of costs and time.

Therefore, considering such a situation, it is desperately needed to solve the problem by finding a cause of the abnormality in process without discontinuity in process and by minimizing the duration of discontinuity if discontinuity is absolutely necessary.

Meanwhile, when a signal that a measurement value of the analyzer exceeds the permissible range and there is abnormality in slurry is received, an engineer inspects the delivery apparatus, the analyzer and the raw materials. In this instance, the engineer checks whether or not the analyzer is abnormal according to an inspection manual or in his or her own way by his or her own long-term experiences.

However, in this case, it takes a long time till the engineer approaches and checks the analyzer, and in case of the engineer without much experience, the engineer may make a wrong decision and it may increase the process loss.

Finally, the conventional measures to the signal of abnormality in process have several problems in that there is inaccuracy and possibility to delay responses and the cost of the process is increased. And it is not easy to solve the problems, thus even if the problems occurs, they are thought to be inevitable problems for the operation of facilities and the engineer is compelled to reduce a response period time.

On the other hand, besides the measurement value of an object to be analyzed, there is another reference to decide abnormality. Measurement is performed in a state where there is no object to be measured or while dropping a material with a fixed measurement value, such as deionized water or nitrogen gas, to a sensor, then, the sensor outputs a reference value or signal which shows the status of the sensor. Such an output signal of the sensor may be outputted in real time regardless of statuses of the system, such as a standby status, a measurement status and a verification status. However, such a method causes a great change in sensor signals according to statuses of the system, provides output of an analog signal type, and cannot accurately find a cause of the change in sensor measurement values.

Because of those, there is a limit in deciding whether or not the sensor in the analyzer is out of order, in deciding analysis results, or whether or not there is abnormality in measurement values through management of the sensor status signals. So, the status signal cannot be properly used in management of process.

In the meantime, when a signal of abnormality relative to an object to be measured is detected while the analyzer is conducting measurement, a substantial part of abnormality is related with malfunction of the measurement sensor, and a substantial part of causes of sensor malfunction is caused by pollution of the sensor or the analyzer.

FIG. 3 is a graph adumbratively showing a change in sensor measurement values over time relative to slurry (indicated by a solid line) and a permissible range (process management specification) of the measurement values and a change in sensor status signals, which are measurement values over time, relative to a standard material (indicated by a dotted line) and a permissible range (sensor signal management specification) of the sensor status signals, which will be compared with the present invention later.

Referring to FIG. 3, the sensor status signals changed due to increase in the pollution level of the sensor while inspection of a slurry sample was repeated, and an influence of the sensor status signals which showed a transitive status change of the sensor could be estimated by means of slurry measurement values. The measurement values of the sensor relative to the slurry sample could not actually show the status of the sample through the status change of the sensor. It is estimated that the transitive status change value, which has been changed while the sensor status signal is gradually polluted from the initial stage up to now, subtracted from the measurement value presently measured by the sensor is the measurement value accurately showing the actual status of the sample. Therefore, even though the measurement value of the sensor exceeds the permissible range of the measurement value relative to the slurry, considering the status change of the sensor, it may be inferred that there is no abnormality in slurry.

Therefore, if it is possible to remove pollution of the sensor or the analyzer by a simple method before the measurement value exceeds the permissible range while continuously checking the status of the sensor not to exceed the permissible range, it can restrain generation of an abnormal signal of the analyzer, can have a chance to verify the initial measurement value of the analyzer again by inspecting the object again after going through the simple process of removing pollution if it is decided that the status of the sensor exceeds the permissible range even though the abnormal signal of the analyzer is detected. Therefore, the method may be a better solution to restrain and prevent discontinuity in process.

### DISCLOSURE

### Technical Problem

Accordingly, the present invention has been made in view of the above-mentioned problems occurring in the prior art, namely, the problem that it is difficult to accurately check a cause of abnormality within a short period of time and it takes much time until delivery of slurry is resumed after being stopped when there is abnormality in the conventional slurry verifying system, and the problem that a great loss is increased due to an inaccurate decision of the cause of abnormality and inappropriate responses to the abnormality. It is an object of the present invention to provide a reliable method, which can immediately decide whether or not an analyzer is abnormal in the shortest time without an engineer's services and judgment, and a slurry verifying system suitable for the method.

In an aspect of the present invention, it is another object of the present invention to provide a method, which can immediately decide whether or not the analyzer is abnormal and make a reliable diagnosis without an engineer's services and judgment if necessary when an abnormal signal is detected through a measurement value of the analyzer while slurry is being delivered and can simply normalize the status of the analyzer in the case that the abnormality in the measurement value is caused by pollution of the analyzer, and a slurry verifying system suitable for the method.

In another aspect of the present invention, it is a further object of the present invention to provide a method, which can effectively manage the slurry verifying system using the status signal of the sensor, which has not been sufficiently used as a management means by the conventional slurry verifying system, and can rapidly and accurately respond to abnormality when the slurry measurement value is abnormal, and a slurry verifying system suitable for the method.

### Technical Solution

To accomplish the above object, according to the present invention, there is provided a verification method in a slurry verifying system, which includes a delivery apparatus for manufacturing and delivering slurry using raw materials, and an analyzer having a sensor receiving slurry from the delivery apparatus to inspect whether or not the slurry is abnormal, the verification method comprising the steps of: if a measurement value of the analyzer exceeds a permissible range and an abnormal signal is generated, supplying a standard material instead of the slurry, which is delivered from the delivery apparatus to the analyzer, to the analyzer in order to obtain a standard material measurement value relative to the standard material; if the standard material measurement value is within a predetermined normal range, judging that there is abnormality in slurry and inspecting the raw material or the delivery apparatus to find a cause of the abnormality; and if the standard material measurement value exceeds the normal range, judging that there is abnormality in the analyzer and taking measures to solve the problem of the analyzer.

When it is judged that the analyzer is abnormal, while supply of slurry is continued, an abnormal part, for instance, a sensor, may be repaired or replaced. In this instance, in order to repair or replace the sensor while operating a slurry delivery line of the delivery apparatus as it is, of course, the slurry delivery line must supply slurry regardless of whether or not the analyzer is operated.

When it is judged that the analyzer is abnormal, first, an analyzer cleaning signal is generated to clean the analyzer. Cleaning may be performed during a predetermined period of time or repeated a predetermined number of times. After cleaning, when it is judged that the analyzer is still abnormal through additional measurement, that is, if the cleaning was not performed properly or there is abnormality in the analyzer, an analyzer inspection signal is sent so that the analyzer is inspected and repaired.

In the present invention, when the analyzer obtains the measurement value relative to the standard material and when it is checked whether or not the standard material measurement value exceeds a predetermined normal range, it may be considered that the measurement value exceeds the predetermined normal range as that a sensor status signal exceeds an analyzer management range. In this case, the base line of the analyzer management range can be obtained by checking the sensor status signal while supplying the standard material.

Measurement of the sensor status signal using the standard material may be divided into a preventive method and a problem-solving method to solve the problem when there occurs a problem due to abnormality in measurement value. In this instance, a method of supplying deionized water to the analyzer on a regular cycle regardless of abnormality in the measurement value relative to the slurry sample to check whether or not the analyzer exceeds an equipment pollution range and cleaning the analyzer when the analyzer exceeds an equipment pollution range is the preventive method. A method of supplying a slurry sample, converting a measurement mode into an equipment verification mode when there is abnormality in the measurement value measured by the sensor, supplying deionized water and cleaning liquid to perform cleaning, supplying the standard material to verify equipment when the sensor status signal relative to the standard material exceeds a sensor management range is the problem-solving method.

In case that the measurement value of the analyzer relative to the standard material is used as the sensor status signal to form base line, it is preferable that management by the analyzer measurement value relative to the standard material be carried out to decide whether or not the analyzer is abnormal on the basis of a smaller or narrower range than the slurry measurement value permissible range i.e. within the slurry measurement value permissible range.

In another aspect of the present invention, there is provided a slurry verifying system suitable for the method. The slurry verifying system which includes the delivery apparatus and the analyzer further includes a standard material supply unit. When the abnormal signal is generated from the analyzer, instead of supplying the slurry manufactured in the delivery apparatus to the analyzer, the standard material supply unit sends a standard material to the analyzer to measure the sensor of the analyzer and to find out and decide whether the abnormal signal is caused by the slurry or the analyzer.

The slurry verifying system further includes an automatic verification module which mediates a signal and a material flow between the delivery apparatus and the analyzer, receives the standard material of the standard material supply unit and the slurry sample of the delivery apparatus to selectively supply the standard material and the slurry.

In order to make it possible that the standard material supply unit sends a standard material to the analyzer to check the sensor of the analyzer and to find out and decide whether the abnormal signal is caused by the slurry or the analyzer instead of that the slurry manufactured in the delivery apparatus is supplied to the analyzer when the abnormal signal is generated from the analyzer, the automatic verification module for mediating the signal and the flow of the slurry sample is mounted between the delivery apparatus and the analyzer, the standard material supply unit is disposed, so that the standard material of the standard material supply unit and the slurry sample of the delivery apparatus are supplied to the analyzer through three-way valves managed by the automatic verification module.

While the standard material is substituted for the slurry sample when there is an abnormal signal, deionized water instead of the standard material is supplied to obtain an analyzer measurement value relative to the deionized water. When it is checked that the measurement value is normal, the standard material instead of the deionized water is supplied to obtain a measurement value relative to the standard material so as to find out a cause of abnormality. For this, the slurry verifying system includes a three-way valve. The standard material supply unit and the deionized water supply unit are connected to two input side of the three-way valve, and an output side of the three-way valve together with the slurry sample of the delivery apparatus is connected to two input sides of another three-way valve, and an output side of the latter three-way valve is connected to the analyzer.

The slurry verifying system, which includes the delivery apparatus, the analyzer and the standard material supply unit, further includes a cleaning liquid supply unit. When it is judged that the standard material measurement value exceeds the normal range, the cleaning liquid supply unit supplies cleaning liquid to the analyzer to clean and restore the analyzer.

In this instance, the automatic verification module for mediating the signal and the material between the delivery system and the analyzer is disposed so that the cleaning liquid supply unit can send cleaning liquid instead of the standard material to the analyzer through a cleaning signal.

### Advantageous Effects

As described above, if there is abnormality in the slurry verifying system, the slurry verifying system according to the present invention can automatically supply the standard material to the analyzer so that the analyzer can measure the standard material, thereby rapidly and accurately deciding whether abnormality is caused by abnormality of the delivery apparatus, the slurry or the analyzer, and solving the problem of abnormality without interruption of slurry supply if the analyzer is abnormal.

The verification method and system according to the present invention can take measures within a short period of time when there is abnormality in the slurry verifying system and save time and expenses by rapidly and reliably deciding abnormality of the analyzer without time delay due to an engineer's services and judgment.

The objects of the present invention can be achieved by adding the automatic verification module, the standard material supply unit, and the cleaning liquid supply unit if necessary to the conventional slurry verifying system. Therefore, the present invention can reduce expenses to buy and install a different slurry verifying system.

### DESCRIPTION OF DRAWINGS

FIG. 1 is a conceptual diagram showing a conventional slurry delivery system and a passage for transmitting a signal inside the system conceptually and briefly.

FIG. 2 is a flow chart showing a process or steps to inspect or measure an analyzer in a conventional slurry verifying system.

FIG. 3 is a graph adumbratively showing a change in sensor status signals relative to slurry over time and a permissible range of the sensor status signals.

FIG. 4 is a conceptual diagram showing a slurry delivery system including a slurry verifying system according to a first preferred embodiment of the present invention.

FIG. 5 is a flow chart showing a flow of operation steps of a method according to the first preferred embodiment of the present invention.

FIG. 6 is a conceptual diagram showing a slurry delivery system including a slurry verifying system according to a second preferred embodiment of the present invention.

FIG. 7 is a flow chart showing a flow of operation steps of a method according to the second preferred embodiment of the present invention.

FIG. 8 is a conceptual diagram showing a slurry delivery system including a slurry verifying system according to a third preferred embodiment of the present invention.

FIG. 9 is a flow chart showing a flow of action steps conducted in the slurry verifying system illustrated in FIG. 8.

FIG. 10 is a graph showing a change of a graph if a sensor status signal is changed after cleaning is conducted at the time of occurrence of abnormality that the sensor status signal exceeds a permissible range according to the third preferred embodiment of the present invention.

FIG. 11 is a graph showing changes in measurement values (in a solid line) and in sensor status signals (in a dotted line) when abnormality occurrence in measurement values is prevented according to another preferred embodiment of the present invention.

FIG. 12 is a conceptual diagram showing a structure of a slurry delivery system having a slurry verifying system according to a fourth preferred embodiment of the present invention.

### MODE FOR INVENTION

Hereinafter, embodiments of the present invention will be described in detail with reference to the accompanying drawings.

### Embodiment 1

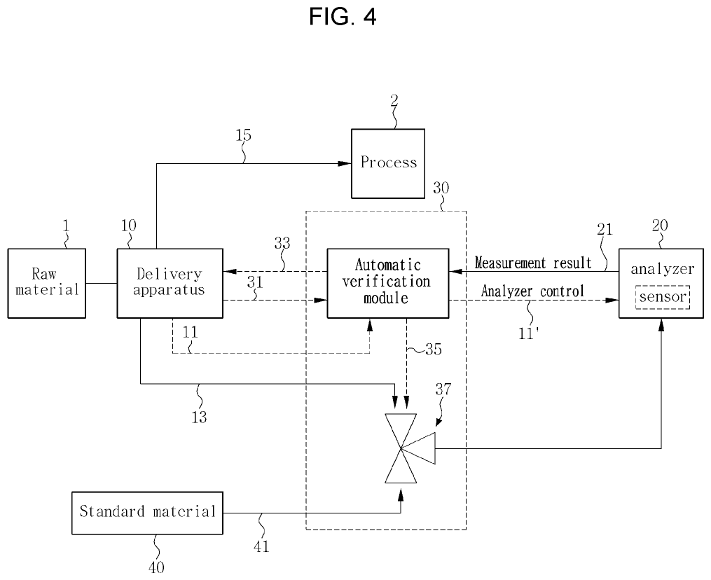

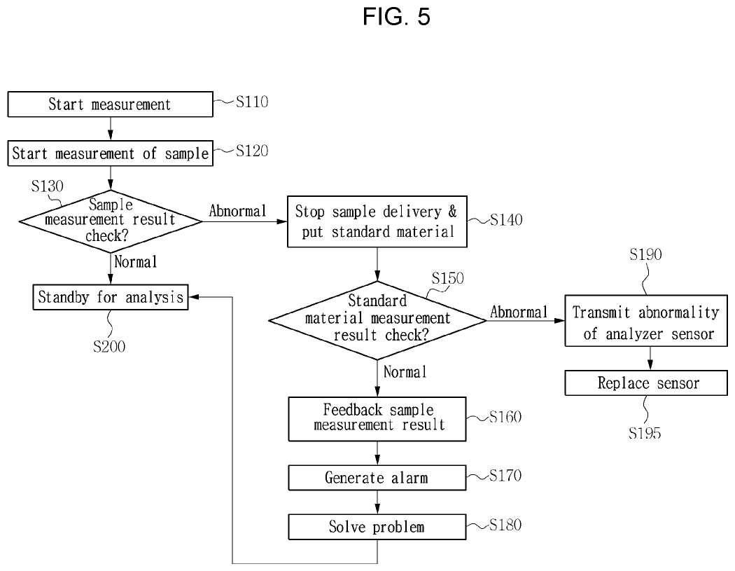

FIG. 4 is a conceptual diagram showing a slurry delivery system including a slurry verifying system according to a first preferred embodiment of the present invention, and FIG. 5 is a flow chart showing a flow of operation steps of a method according to the first preferred embodiment of the present invention.

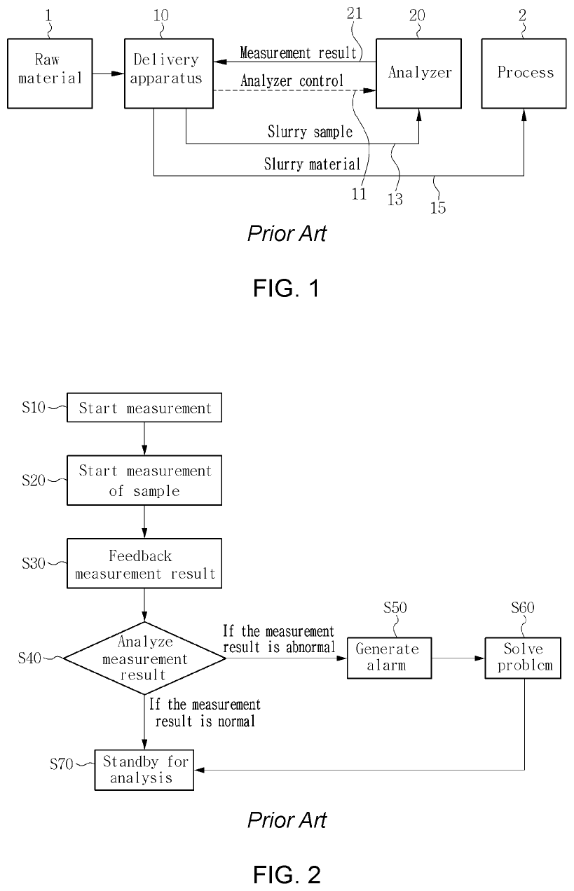

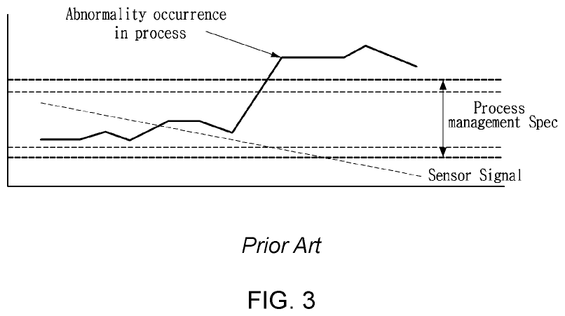

First, the system according to the embodiment of the present invention includes a delivery apparatus 10 and an analyzer 20 like the conventional system illustrated in FIG. 1, and further includes an automatic verification module 30 disposed between the delivery system and the analyzer and a standard material supply unit 40. A standard material of the standard material supply unit 40 and a slurry sample of the delivery apparatus 10 are supplied to the analyzer 20 through a three-way valve 37 managed by the automatic verification module. Here, the three-way valve may be a part of the automatic verification module 30 indicated by a dotted line in a broad sense.

Referring to FIGS. 4 and 5, a process of analyzing by the slurry verifying system will be described. In the ordinary way, the automatic verification module serves as a medium passing through a flow of a signal and a material between the delivery apparatus 10 and the analyzer 20. When measurement starts (S110), the automatic verification module transmits an analyzer control signal and the slurry sample of the delivery system to the analyzer, and starts measurement in the analyzer 20 (S120). After that, the automatic verification module checks a measurement result of the obtained slurry sample (S130), and directly transmits the measurement value to a main controller of the delivery apparatus 10 if the measurement value is normal.

However, if the measurement value is abnormal, the automatic verification module converts the measurement mode into a verification mode, and does not transmit the abnormal measurement value to the delivery apparatus but transmits the previous normal measurement value as occasion demands so that the delivery apparatus can keep its normal operation.

Therefore, the analyzer control signal of the delivery apparatus is continuously transmitted so that the analyzer continues its inspection action and slurry is also continuously delivered from the delivery apparatus to the process.

When the mode is converted into the verification mode, the automatic verification module sends a three-way valve control signal through a signal line 35 in order to interrupt delivery of the slurry sample, and sends a standard material to a sensor of the analyzer 20 in order to inspect or measure the standard material (S140).

Here, the standard material is a material having ideal conditions, which is managed to keep a predetermined characteristic value or a characteristic value range at the time of measurement when the analyzer is in a normal state or in a standard state. Therefore, it is necessary to inspect the standard material at predetermined periods and to be replaced and renewed if necessary.

The automatic verification module checks a standard material measurement value, which is a measurement result of the analyzer relative to the standard material, by the analyzer (S150). If the measurement value exceeds the permissible range, on the assumption that there is no error in the standard material, the automatic verification module transmits a signal indicating that the analyzer or the sensor is abnormal (S190) in order to call an operator or an engineer in charge. Then, the operator or the engineer takes measures to normalize operation of the analyzer, for instance, to replace the sensor with a new one (S195). The steps S190 and S195 in the drawings may be simply expressed as a ‘request for LPC inspection’.

In the above case, because there is actually no abnormality in slurry, it is preferable to continuously send the previous measurement value to the delivery apparatus to keep the normal action. Only when it is inevitable to interrupt the whole of the slurry verifying system, for instance, to replace the analyzer sensor with a new one, the process is stopped or a warning alarm is generated through the delivery apparatus.

On the other hand, if the standard material measurement value is within the permissible range, on the basis that there is no abnormality in the analyzer and the slurry is abnormal from the start, the automatic verification module transmits the abnormal measurement value to the delivery apparatus (S160). In this instance, the delivery apparatus generates an alarm (S170) to call the operator or the engineer in charge in order to find and decide abnormality in raw materials or abnormality in equipment, such as a material mixer of the delivery apparatus, which causes abnormality of slurry and to take measures for normalization (s180).

### Embodiment 2

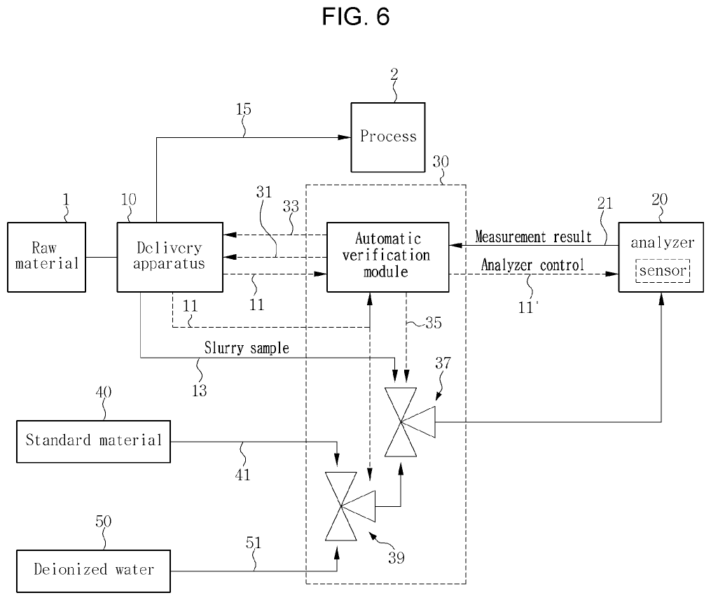

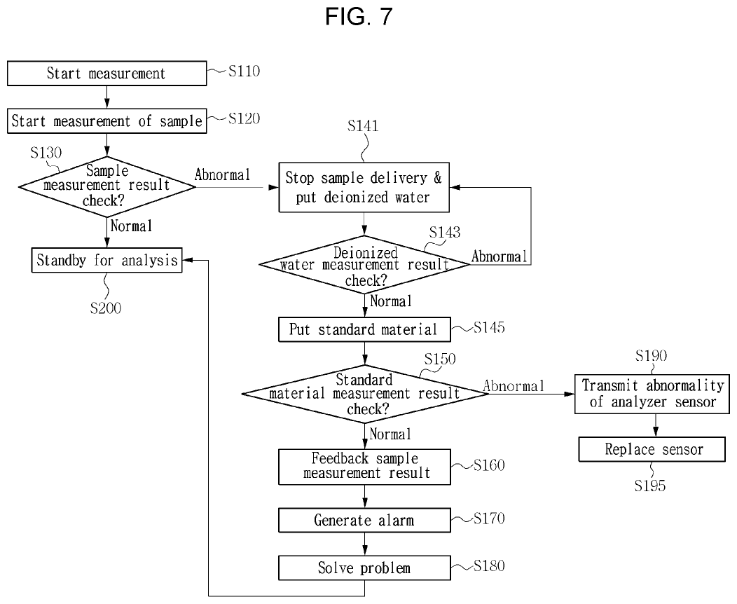

FIG. 6 is a conceptual diagram showing a slurry delivery system including a slurry verifying system according to a second preferred embodiment of the present invention, and FIG. 7 is a flow chart showing a flow of operation steps of a method according to the second preferred embodiment of the present invention.

As shown in FIG. 4, the slurry verifying system includes a delivery apparatus 10 and an analyzer 20, and further includes an automatic verification module 30 disposed between the delivery system and the analyzer, a standard material supply unit 40, and a deionized water supply unit 50. In the previous embodiment, a standard material of the standard material supply unit 40 and a slurry sample of the delivery apparatus 10 are supplied to a sensor of the analyzer 20 through one three-way valve 37 managed by the automatic verification module. However, in this embodiment, two three-way valves 37 and 39 are mounted. First, two branches of the first three-way valve 39 are respectively connected with the standard material supply unit 40 and the deionized water supply unit 50, and two branches of the second three-way valve 37 are connected with the other branch of the first three-way valve 39 and the delivery apparatus 10, and the other branch of the second three-way valve 37 is connected with the sensor of the analyzer 20.

If the standard material is directly supplied after blocking slurry, it cannot provide an accurate result since the slurry remaining in the analyzer is mixed with the standard material. Therefore, after blocking of the slurry, deionized water is sent to the analyzer to clean the inside of the analyzer. After sufficient cleaning of the analyzer, the standard material is supplied, so that accurate inspection can be made.

Of course, if the standard materials flow for a sufficient period of time, the slurry can be sufficiently purged and an accurate measurement value can be obtained. However, it may cause waste of the standard material and time.

Here, the first and second three-way valves may be a part of the automatic verification module 30′ in a broad sense.

In the ordinary way, like the previous embodiment, the automatic verification module transmits an analyzer control signal and the slurry sample of the delivery apparatus to the analyzer, and directly transmits the measurement result or the measurement value relative to the obtained slurry sample to the delivery apparatus if the measurement result or the measurement value is normal.

However, if the measurement value is abnormal, the automatic verification module converts the measurement mode into a verification mode, and does not transmit the abnormal measurement value to a main controller but transmits the previous normal measurement value as occasion demands so that the delivery system can keep its normal operation.

When the mode is converted into the verification mode, the automatic verification module sends first and second three-way valve control signals so that delivery of the slurry sample is interrupted by the second three-way valve, and sends output of the first three-way valve to the analyzer. After that, the first three-way valve sends the deionized water, which was supplied from the deionized water supply unit, to the sensor of the analyzer through the second three-way valve in order to conduct inspection of deionized water (S141).

After that, an inspection result of the deionized water is checked (S143), and then, if a value within a predetermined range is not obtained, the automatic verification module continues the inspection while continuously supplying deionized water. Moreover, if the value within the predetermined range is not still obtained through the inspection of deionized water even after the number of predetermined times being inspected, the automatic verification module judges it as a problem of the analyzer and may generate an analyzer inspection signal.

Furthermore, if a normal value is obtained, as the inspection result relative to deionized water, the automatic verification module controls the first three-way valve so that the standard material sample is delivered to the sensor of the analyzer through the second three-way valve to do inspection of the standard material (S145).

A flow of the next steps is the same as the previous embodiment. That is, the automatic verification module checks the standard material measurement value, which is the measurement result of the analyzer relative to the standard material from the analyzer (S150). If the standard material measurement value exceeds the permissible range, the automatic verification module takes measures on the basis that there is abnormality in the analyzer or the sensor. Also in this embodiment, the steps S190 and S195 in the drawings may be simply expressed as a ‘request for LPC inspection’.

Additionally, if the standard material measurement value is within the permissible range, on the basis that there is abnormality in slurry or the delivery system, the automatic verification module transmits the abnormal measurement value to the delivery apparatus. In this instance, the delivery apparatus generates an alarm to call the operator or the engineer in charge in order to find and decide abnormality in raw materials or abnormality in components, such as a material mixer of the delivery system, which causes abnormality of slurry and to take measures for normalization.

### Embodiment 3

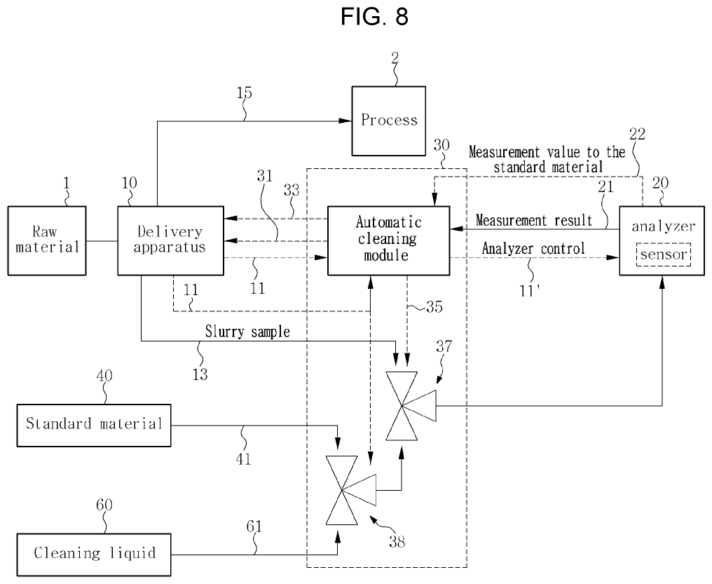

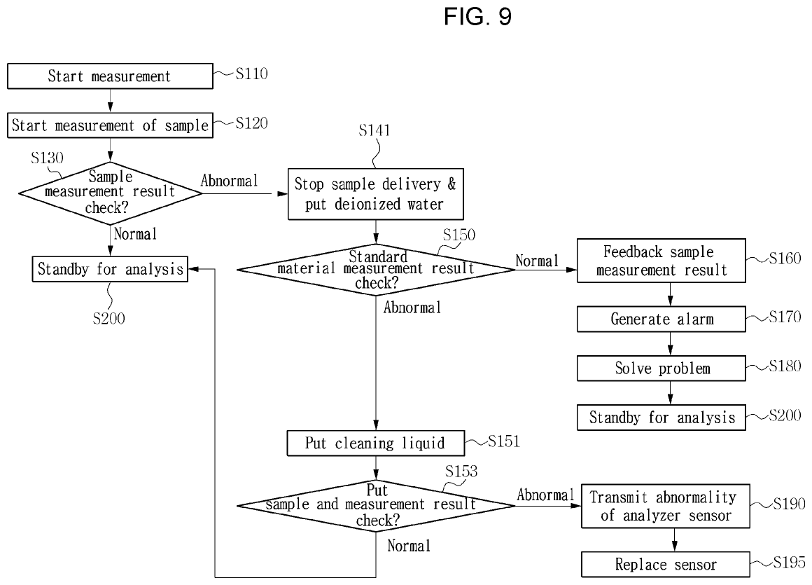

FIG. 8 is a conceptual diagram showing a slurry delivery system including a slurry verifying system according to a third preferred embodiment of the present invention, and FIG. 9 is a flow chart showing a flow of action steps conducted in the slurry verifying system illustrated in FIG. 8.

Referring to the drawings, the slurry verifying system according to the third preferred embodiment of the present invention includes: a delivery apparatus 10 for producing slurry and delivering the slurry to a process; an analyzer 20 for receiving a slurry sample made in the delivery apparatus 10 through a sample line 13, analyzing the slurry sample to obtain a management object characteristic value; an automatic cleaning module 30 mediating a flow of a signal and a material between the delivery system and the analyzer and cleaning the analyzer if it is judged that the analyzer is abnormal, wherein the automatic cleaning module 30 is a sort of the automatic verification module; a standard material supply unit 40 for selectively supplying a slurry sample and a standard material according to a control signal 35 of the automatic cleaning module 30; and a cleaning liquid supply unit 60 for selectively supplying the standard material and a cleaning liquid.

In order to selectively supply the slurry, the standard material or the cleaning liquid with respect to a sensor, in this embodiment, two three-way valves 37 and 38 which are operated by the control signal 35 of the automatic cleaning module 30 is mounted.

First, two branches of the first three-way valve 38 are respectively connected to the standard material supply unit 40 and the cleaning liquid supply unit 60, two branches of the second three-way valve 37 are connected with the other branch (output branch) of the first three-way valve 38 and a slurry sample line 13 of the delivery system 10, and the other branch (output branch) of the second three-way valve 37 is connected with the sensor of the analyzer.

Of course, signal lines to transmit a signal and other supply lines for transferring the material between elements may be provided.

In the slurry verifying system, the delivery apparatus 10 receives raw materials of a raw material supply unit 1 and mixes slurry, and then, delivers the slurry to a process 2 and the analyzer 20 through the supply line 15 and the sample line 13. A PLC of the delivery apparatus generates a control signal to transfer the slurry to the analyzer 20 through the signal line and the automatic cleaning module 30 (radio signal is transferred through air) in order to inspect and measure the slurry (S110). Therefore, in the analyzer, the sensor conducts inspection and measurement to the slurry sample (S120).

The measurement value, which is the measurement result, is transmitted to the automatic cleaning module through the signal line 21 to be judged (S130). If it is judged that the measurement value is within a normal range, the measurement value is transmitted to the PLC of the delivery apparatus through the signal line 31, and the delivery apparatus is in a standby state for the next measurement (S200) since the analyzer control signal and the slurry sample are continuously supplied from the delivery apparatus.

If the measurement value is transmitted to the automatic cleaning module 30 and it is judged that the measurement value exceeds the permissible range, because the cause of abnormality is not found out, the automatic cleaning module sends the previous normal slurry measurement value to the delivery system so that the delivery system operates normally. After that, the automatic cleaning module converts the normal mode into a base line mode, then delivery of the object material sample to the analyzer is interrupted and the standard material is supplied from the standard material supply unit 40 to the analyzer 20 (S141).

Therefore, the analyzer measures the standard material, and transmits the measurement value to the automatic cleaning module 30 through the signal line 22 to decide the measurement value (S150).

If the measurement value is within the permissible range, the automatic cleaning module 30 judges that there is no abnormality in the analyzer and the abnormal signal is caused by the slurry, and transmits the abnormal signal or the abnormal measurement value, which was previously obtained but was postponed in delivery, to the delivery apparatus (S160). Therefore, the delivery apparatus 10 decides abnormality of the slurry and generates an alarm (S170), so that an operator or an engineer checks whether or not there is any abnormality in raw materials or a slurry manufacturing device, such as a mixer of the delivery system, and takes measures to solve the problem (S180).

If the measurement value exceeds the permissible range, the automatic cleaning module 30 judges that there is abnormality in the analyzer, and interrupts delivery of the standard material before sending an analyzer inspection request signal, and supplies cleaning liquid to the analyzer instead of the standard material in order to try to solve the problem of abnormality in the analyzer (S151). Next, in order to check whether or not the problem of abnormality in the analyzer is solved well, the automatic cleaning module 30 sends the slurry sample or the standard material to the analyzer 20 in order to check whether the slurry or the standard material is in the permissible range (S153).

If the slurry or the standard material is in the permissible range, the automatic cleaning module judges that the analyzer has been restored to a normal state and converts the verification mode into the normal mode so that slurry is continuously delivered to the analyzer and the system is in the standby state for continuous inspection (S200).

If the slurry continuously exceeds the permissible range, the automatic cleaning module judges that it is difficult to restore the analyzer by the cleaning liquid, generates and transmits a sensor abnormal signal (S190), and the operator or the engineer takes measures, such as replacement of the sensor (S195). Also in this embodiment, the steps 5190 and 5195 in the drawings may be simply expressed as a ‘request for LPC inspection’.

Generally, in these cases, because the analyzer is abnormal but the slurry is not abnormal, the delivery system for delivering slurry to the process continuously performs its function without stop so as to effectively prevent a loss in process caused by stop of slurry supply.

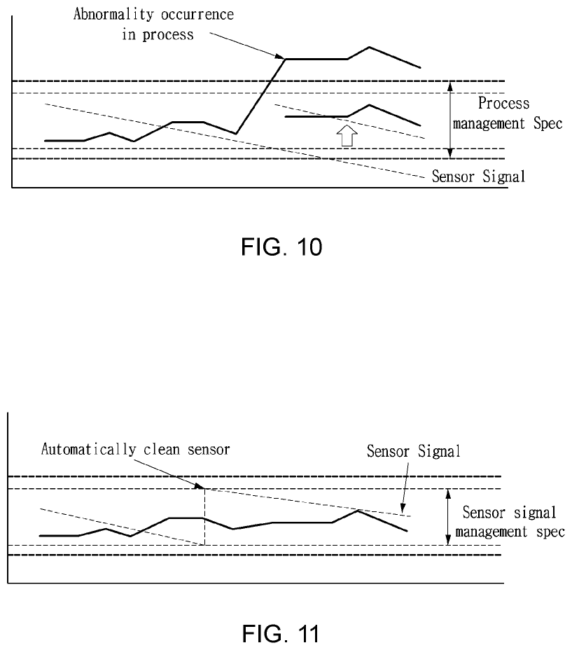

FIG. 10 is a graph showing changes of sensor status signal and measurement value of slurry after cleaning is conducted at the time of occurrence of abnormality that the sensor status signal exceeds a permissible range according to the third preferred embodiment of the present invention.

Here, because the sensor status signal moves parallel in the direction of the arrow as high as a value increasing through automatic cleaning, the measurement value is within a normal process management range, namely, the permissible range. Therefore, there is no abnormality in slurry, and there is no need to stop delivery of slurry and the main process.

FIG. 11 is a graph showing changes in measurement values (in a solid line) and in sensor status signals (in a dotted line) when abnormality occurrence in measurement values is prevented according to another preferred embodiment of the present invention.

In this embodiment, the automatic cleaning module figures out the sensor status signal while periodically dropping the standard material, for instance, a material with specific characteristics, to the analyzer, finds out development of changes of the signal status signal, and automatically supplies the cleaning liquid at the point of time that the sensor status signal exceeds the normal sensor management range (sensor signal management specification: permissible range) in order to automatically clean the analyzer. Then, the sensor status signal and the measurement value are changed, so that generation of an abnormal signal can be prevented since the measurement value does not exceed the process management range (process management specification).

### Embodiment 4

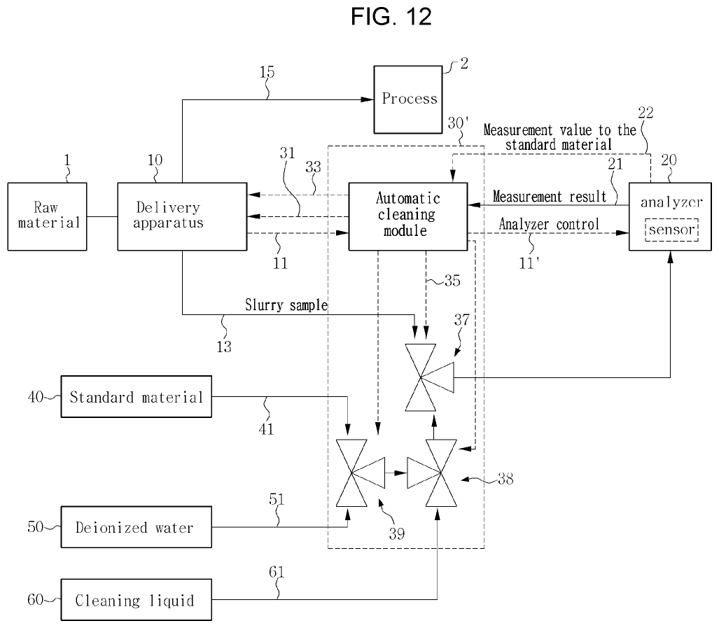

FIG. 12 is a conceptual diagram showing a structure of a slurry delivery system having a slurry verifying system according to a fourth preferred embodiment of the present invention.

Compared with the third preferred embodiment illustrated in FIG. 8, the slurry verifying system includes a standard material supply unit 40 and a deionized water supply unit 50. The standard material supply unit 40 and the deionized water supply unit 50 are connected to two input sides of the third three-way valve 39, and an output side of the third three-way valve 39 is connected with two input sides of the first three-way valve 38 together with a cleaning liquid supply unit 60.

That is, in order to selectively supply slurry, the standard material, deionized water and cleaning liquid to the sensor, the slurry verifying system according to this embodiment includes the two three-way valves 37 and 38 operated by a control signal of an automatic cleaning module 30′ and one three-way valve 39 additionally mounted.

Here, two branches of the input side of the third three-way valve 39 are connected to the standard material supply unit 40 and the deionized water supply unit 50, and the output side of the third three-way valve 39 is connected with two input sides of the first three-way valve 38 together with the cleaning liquid supply unit 60.

Two branches of the input side of the second three-way valve 37 are connected with the output side of the first three-way valve 39 and a slurry sample line 13 of the delivery apparatus 10, and the output side, which the other branch of the second three-way valve 37 is connected with the sensor of the analyzer 20.

Such a structure is closer to reality than the structure illustrated in FIG. 8. If the standard material is supplied after interruption of slurry, because the slurry remaining in the analyzer is mixed with the standard material, an accurate result cannot be obtained. Therefore, after interruption of slurry, first deionized water is sent to the analyzer to clean the slurry in the analyzer. When cleaning is finished, the standard material is supplied for accurate inspection.

Except the above differences, other structures or process flows may be performed in the same way as the previous embodiment illustrated in FIG. 4.

As described above, while the present invention has been described in connection with the limited embodiments and drawings, they have been provided only to help more general understanding of the present invention, and the present invention is not limited to the embodiments.

Therefore, it will be understood by those skilled in the art that various modifications and changes may be made without deviating from the spirit or scope of the invention and such modifications and changes belong to the scope equivalent to the claims.

1. An automatic verification method of a large-sized particle counter for analyzing CMP slurry in a slurry delivery system, which includes a delivery apparatus for manufacturing and delivering slurry using raw materials, and an analyzer having a sensor receiving a slurry sample from the delivery apparatus to inspect whether or not the slurry is abnormal, the automatic verification method comprising the steps of:
if a measurement value of the analyzer exceeds a permissible range and an abnormal signal is generated, supplying a standard material instead of the slurry, which is delivered from the delivery apparatus to the analyzer, to the analyzer so that the analyzer obtains a standard material measurement value relative to the standard material;
if the standard material measurement value is within a predetermined normal range, judging that there is abnormality in slurry and inspecting the raw material or the delivery system to find a cause of the abnormality; and
if the standard material measurement value exceeds the normal range, judging that there is abnormality in the analyzer and taking measures to solve the problem of the analyzer.

2. The automatic verification method according to claim 1, wherein before obtaining the standard material measurement value, the analyzer does not transmit the abnormal signal to the delivery apparatus but transmit a previous normal value, and
wherein after checking that the standard material measurement value exceeds the normal range, the analyzer transmits the abnormal signal to the delivery apparatus to generate an alarm.

3. The automatic verification method according to claim 1, wherein the measures to solve the problem of the analyzer include automatic cleaning of the sensor.

4. A verifying system of a large-sized particle counter for analyzing CMP slurry to realize any one among the methods according to claim 1, the verifying system comprising:
an automatic verification module mediating a signal and a material between the delivery apparatus and the analyzer; and a standard material supply unit,
wherein the automatic verification module does not supply the slurry sample manufactured in the delivery apparatus to the analyzer but the standard material supply unit sends a standard material to the analyzer to be measured when the abnormal signal is generated from the analyzer.

5. The verifying system according to claim 4, wherein the automatic verification module includes a second three-way valve, so that the delivery apparatus does not supply the slurry sample manufactured in the delivery system to the analyzer but the standard material supply unit sends a standard material to the analyzer to be measured when the abnormal signal is generated from the analyzer,
wherein two input sides of the second three-way valve are respectively connected to the delivery apparatus for delivering the slurry sample and the standard material supply unit, and an output side of the second three-way valve is connected to the analyzer, and
wherein a selection operation of the second three-way valve is performed by a selection signal of the automatic verification module.

6. The verifying system according to claim 4, further comprising:
a deionized water supply unit; and
a first three-way valve, which supplies deionized water of the deionized water supply unit so that the analyzer obtains a measurement value relative to the deionized water when the abnormal signal is generated and supplies the standard material to obtain a measurement value relative to the standard material when it is checked that the measurement value is normal,
wherein the standard material supply unit and the deionized water supply unit are connected to two input sides of the first three-way valve, output sides of the first three-way valve are connected to the two input sides of the second three-way valve likewise with the delivery apparatus for delivering the slurry sample, and the output side of the second three-way valve is connected to the analyzer.

7. A verifying system of a large-sized particle counter for analyzing CMP slurry to realize any one among the methods according to claim 1, the verifying system comprising:
a standard material supply unit
wherein the standard material supply unit sends a standard material to the analyzer to check the sensor of the analyzer when the abnormal signal is generated from the analyzer, instead of that the slurry sample manufactured in the delivery apparatus is supplied to the analyzer.

8. The verifying system according to claim 7, further comprising:
a cleaning liquid supply unit for supplying cleaning liquid to the sensor in order to clean the sensor when the standard material measurement value exceeds the normal range.

9. The verifying system according to claim 8, further comprising:
a deionized water supply unit for supplying deionized water while converted two materials are supplied when the slurry, the standard material and the cleaning liquid, which are materials supplied to the sensor, are converted therebetween.
